(19) United States
(12) Patent Application Publication
(10) Pub. No.: US 2011/0234586 A1
(43) Pub. Date: Sep. 29, 2011

(54) IMAGE SIGNAL PROCESSING DEVICE AND ACTIVE SHUTTER GLASSES

(76) Inventor: Toshimichi AOKI, Osaka (JP)

(21) Appl. No.: 13/070,585

(22) Filed: Mar. 24, 2011

(30) Foreign Application Priority Data
Mar. 26, 2010 (JP) 2010-072006

(51) Int. Cl. G06T 15/00

(52) U.S. Cl. 345/419

(57) ABSTRACT

The image signal processing device includes: an image signal obtainment unit which obtains a three-dimensional image signal for allowing three-dimensional viewing of images using a pair of active shutter glasses; an output unit which outputs the three-dimensional image signal; a judgment unit which judges whether or not the pair of active shutter glasses is in a valid state which allows three-dimensional viewing using the pair of active shutter glasses, based on a result of obtaining information from outside the image signal processing device; and a control unit which switches, by controlling the output unit, an output signal from the output unit, from the three-dimensional image signal to a two-dimensional image signal associated with the three-dimensional image signal, when a result of the judgment by the judgment unit indicates that the pair of active shutter glasses is not in the valid state.

### BACKGROUND OF THE INVENTION

(1) Field of the Invention

The present invention relates to image signal processing devices which process a three-dimensional image signal, and particularly to an image signal processing device used in an apparatus that alternately outputs left and right image signals which compose three-dimensional images and allows the images represented by the left and right image signals to be viewed alternately in a left and right eye, respectively, using a pair of active shutter glasses.

(2) Description of the Related Art

A technique regarding a conventional three-dimensional display apparatus which allows three-dimensional viewing using active shutter glasses (also called “liquid crystal shutter glasses” and hereafter denoted simply as “glasses”) is disclosed in, for example, Japanese Unexamined Patent Application Publication No. 9-90292 (Patent Reference 1).

According to the technique disclosed in Patent Reference 1, when the remaining battery level of the active shutter glasses falls below a predetermined level during the reproduction of three-dimensional images, the user is clearly made aware of the battery run-out in a state where the user is wearing the glasses.

### SUMMARY OF THE INVENTION

Here, aside from the glasses running out of batteries during a period in which three-dimensional images are displayed by a three-dimensional image display apparatus such as a television, there are also cases where, due to the occurrence of some change in situation at the glasses-side such as the glasses coming off, three-dimensional images are viewed under a situation that is not intended by the user.

Specifically, in the active shutter glasses, shutter control is performed by receiving a synchronization signal through infrared rays transmitted from the three-dimensional image display apparatus, and converting the synchronization signal into an electrical signal for control.

Furthermore, the three-dimensional image display apparatus displays three-dimensional images on the display while transmitting the synchronization signal, without checking whether or not the glasses are receiving the synchronization signal. Therefore, even when the user is not wearing the glasses, such as when the glasses worn by the user comes off, and so on, three-dimensional images are displayed on the display in the same manner as when the user is wearing the glasses.

Specifically, in this case, aside from the occurrence of normally unnecessary processing such as the left-eye images and right-eye images being displayed continuously even in a period in which the display of three-dimensional images is unnecessary, a situation in which it is difficult for the user to check the displayed material also arises.

Thus, the present invention is conceived in view of the conventional problems and has as an object to provide (i) an image signal processing device which is an image signal processing device for three-dimensional viewing using active shutter glasses, and which is intended for effective switching of image display modes, and (ii) active shutter glasses.

In order to solve the aforementioned problems, the image signal processing device according to an aspect of the present invention is an image signal processing device which includes: an image signal obtainment unit configured to obtain a three-dimensional image signal for allowing three-dimensional viewing of images using a pair of active shutter glasses; an output unit configured to output the three-dimensional image signal; a judgment unit configured to judge whether or not the pair of active shutter glasses is in a valid state which allows three-dimensional viewing using the pair of active shutter glasses, based on a result of obtaining information from outside the image signal processing device; and a control unit configured to switch, by controlling the output unit, an output signal from the output unit, from the three-dimensional image signal to a two-dimensional image signal associated with the three-dimensional image signal, when a result of the judgment by the judgment unit indicates that the pair of active shutter glasses is not in the valid state.

According to this configuration, a two-dimensional image signal is outputted in place of the three-dimensional image signal when the active shutter glasses are not in the valid state. Specifically, in a situation in which the display of three-dimensional images is unnecessary, the occurrence of an inefficient situation such as the continuance of processing for outputting the three-dimensional image signal is suppressed, and information is displayed to the user in a mode that allows clear viewing.

Therefore, the image signal processing device according to this aspect allows effective switching of image display modes.

Furthermore, the image signal processing device according an aspect of the present invention may further include a communication unit configured to receive a predetermined signal from the pair of active shutter glasses, the predetermined signal being the information from outside the image signal processing device, wherein the judgment unit may be configured to judge that the pair of active shutter glasses is not in the valid state when the communication unit does not receive the predetermined signal from the pair of active shutter glasses.

According to this configuration, when, for example, the power source of the active shutter glasses is not ON, the active shutter glasses are judged as not being in the valid state because the predetermined signal is not transmitted from the active shutter glasses.

Furthermore, a case is assumed in which the predetermined signal is transmitted according to a communication scheme that uses highly directional electromagnetic waves such as infrared rays. In this case, the communication unit can be disposed so as to judge that the active shutter glasses are not in the active state, regardless of whether or not the predetermined signal is being transmitted, when the active shutter glasses are not facing in the direction of the screen on which the three-dimensional images are being displayed.

In this manner, in the image signal processing device according to the this aspect, whether or not the active shutter glasses are in a valid state is judged appropriately according to the presence of the predetermined signal from the active shutter glasses, which is a result of obtaining information from the outside.

Furthermore, in the image signal processing device according an aspect of the present invention, the judgment unit may be configured to judge that the pair of active shutter glasses is not in the valid state when the communication unit does not receive the predetermined signal for a predetermined period of time.

According to this configuration, the accuracy of the judgment as to whether or not the active shutter glasses are in the active state can be improved through a simple processes such as measuring the period during which the predetermined signal is not received.

Furthermore, in the image signal processing device according an aspect of the present invention, the communication unit may be configured to transmit an inquiry signal to the pair of active shutter glasses, and the judgment unit may be configured to judge that the pair of active shutter glasses is not in the valid state when the communication unit does not receive the predetermined signal as a response to the inquiry signal.

According to this configuration, in the image signal processing device according to this aspect, it is possible to confirm whether or not the active shutter glasses are in the valid state by inquiring to the active shutter glasses as necessary. As a result, for example, the process for effective switching between three-dimensional image display and two-dimensional image display becomes more efficient.

Furthermore, the image signal processing device according an aspect of the present invention may further include a captured-image data obtainment unit configured to obtain captured-image data which is the information from outside the image signal processing device, obtained by capturing an image of a view in front of a screen on which images based on the three-dimensional image signal outputted from the output unit are displayed, wherein the judgment unit may be configured to judge whether or not the pair of active shutter glasses is in the valid state, according to a result of an analysis of the captured-image data.

According to this configuration, even when the active shutter glasses do not have, for example, a function for transmitting the predetermined signal, it is possible to judge whether or not the active shutter glasses are in the valid state.

Furthermore, in the image signal processing device according an aspect of the present invention, when the result of the judgment indicates that the pair of active shutter glasses is not in the valid state, the control unit may be configured to switch, by controlling the output unit, the output signal from the output unit, from the three-dimensional image signal to an image signal which is the two-dimensional image signal and is for displaying information indicating an occurrence of a state caused by the pair of active shutter glasses not being in the valid state.

According to this configuration, it is possible to output, for example, (i) text information indicating the occurrence of a state caused by the pair of active shutter glasses not being in the valid state such as “unable to confirm valid active shutter glasses”, or “unable to display 3D images”, and so on, or (ii) images indicating the same information, and so on. Furthermore, since such information is displayed as two-dimensional images, it is possible to allow the user to clearly view the information when the active shutter glasses are not in the valid state.

Furthermore, the active shutter glasses in an aspect of the present invention is a pair of active shutter glasses which performs an operation of alternately blocking a field of vision of a left eye and a field of vision of a right eye of a user in synchronization with switching between each of left-eye images and right-eye images which are displayed alternately, the pair of active shutter glasses including a communication unit configured to transmit, during an operational period, a predetermined signal which can be received by a device on a displaying-side of the left-eye images and the right-eye images, the operational period being a period of time during which the pair of active shutter glasses performs the operation.

According to this configuration, the predetermined signal indicating that the active shutter glasses are in operation can be transmitted to a device at the image displaying-side (a reproduction apparatus or a display apparatus). Specifically, the device on the displaying-side that is capable of receiving such predetermined signal can judge whether or not the active shutter glasses are in the active state depending on whether or not the predetermined signal is received.

Therefore, the active shutter glasses according to the this aspect can cause the image signal processing device according to any of the above described aspects to perform effective switching of image display modes.

Furthermore, in the pair of active shutter glasses according an aspect of the present invention, when it is the operational period and an inquiry signal is received from the device on the displaying-side, the communication unit may be configured to transmit the predetermined signal as a response to the inquiry signal.

According to this configuration, when there is an inquiry, the active shutter glasses according to this aspect can transmit the predetermined signal as a response to the inquiry. As a result, for example, the process for effective switching between three-dimensional image display and two-dimensional image display becomes more efficient.

Furthermore, the pair of active shutter glasses according an aspect of the present invention may further include a detection unit configured to detect whether or not the pair of active shutter glasses is in a wearing state which is a state of being worn by the user, wherein the communication unit may be configured to transmit the predetermined signal when it is the operational period and a result of the detection by the detection unit indicates the wearing state.

According to this configuration, it is possible for the active shutter glasses to transmit the predetermined signal only in the period in which the active shutter glasses are operating and are being worn by the user. In other words, it is possible to allow a device on the image displaying-side to accurately judge whether or not the active shutter glasses are in the valid state.

Furthermore, the pair of active shutter glasses according an aspect of the present invention may further include a detection unit configured to detect an amount of tilt of a lateral axis of the pair of active shutter glasses with respect to a lateral axis of three-dimensional images based on the left-eye images and the right-eye images, wherein the communication unit may be configured to transmit the predetermined signal when it is the operational period and a result of the detection by the detection unit indicates that the amount of tilt is within a predetermined range.

According to this configuration, when the three-dimensional images which utilize left-right parallax cannot be viewed properly even when the active shutter glasses are operating normally, such as when the user lies down while wearing the active shutter glasses, and so on. In other words, it is possible to allow a device on the image displaying-side to accurately judge whether or not the active shutter glasses are in the valid state.

Furthermore, the present invention can also be realized as an image signal processing method including the characteristic processes executed by the image signal processing device according to any of the above-described aspects. Furthermore, the present invention can also be realized as a program which causes a computer to execute the respective processes included in the image signal processing method, and as a recording medium on which such program is recorded. In addition, the program can also be distributed via a transmitting medium such as the Internet or a recording medium such as a DVD.

Furthermore, the present invention can also be realized as an integrated circuit that includes part or all of the components of the image signal processing device according to any of the above-described aspects.

Furthermore, the present invention can also be realized as a method of controlling active shutter glasses, including the characteristic processes executed by the active shutter glasses according to any of the above-described aspects. Furthermore, the present invention can also be realized as a program which causes a computer to execute the respective processes included in the control method, and as a recording medium on which such program is recorded. In addition, the program can also be distributed via a transmitting medium such as the Internet or a recording medium such as a DVD.

Furthermore, the present invention can also be realized as an integrated circuit that includes part or all of the components of the active shutter glasses according to any of the above-described aspects.

The present invention can provide (i) an image signal processing device which is an image signal processing device for three-dimensional viewing using active shutter glasses, and which is intended for effective switching of image display modes, and (ii) active shutter glasses.

### FURTHER INFORMATION ABOUT TECHNICAL BACKGROUND TO THIS APPLICATION

The disclosure of Japanese Patent Application No. 2010-072006 filed on Mar. 26, 2010, including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is diagram showing a configuration outline of an image display system according to Embodiment 1;

FIG. 2 is a block diagram showing a basic functional configuration of a three-dimensional image display apparatus according to Embodiment 1;

FIG. 3 is a diagram showing a basic hardware configuration of a three-dimensional image reproduction apparatus according to Embodiment 1;

FIG. 4 is a diagram showing a basic hardware configuration of the three-dimensional image display apparatus according to Embodiment 1;

FIG. 5 is a diagram showing a basic hardware configuration of active shutter glasses according to Embodiment 1;

FIG. 6 is a flowchart showing a first example of the flow of processes performed by the three-dimensional image display apparatus according to Embodiment 1;

FIG. 7 is a flowchart showing a second example of the flow of processes performed by the three-dimensional image display apparatus according to Embodiment 1;

FIG. 8A is a flowchart showing an example of the flow of processes related to the switching of image display modes, performed by the three-dimensional image display apparatus according to Embodiment 1;

FIG. 8B is a flowchart showing an example of the flow of processes related to the switching of the image display modes, performed by the three-dimensional image reproduction apparatus according to Embodiment 1;

FIG. 9 is a flowchart showing a third example of the flow of processes performed by the three-dimensional image display apparatus according to Embodiment 1;

FIG. 10 is diagram showing a configuration outline of an image display system according to Embodiment 2;

FIG. 11 is a block diagram showing a basic functional configuration of a three-dimensional image reproduction apparatus according to Embodiment 2;

FIG. 12 is a diagram showing a basic hardware configuration of the three-dimensional image reproduction apparatus according to Embodiment 2;

FIG. 13 is a diagram showing a basic hardware configuration of the three-dimensional image display apparatus according to Embodiment 2;

FIG. 14 is a flowchart showing an example of the flow of processes performed by the three-dimensional image reproduction apparatus according to Embodiment 2;

FIG. 15A is a block diagram showing an example of a functional configuration of an image signal processing device according to Embodiments 1 and 2;

FIG. 15B is a block diagram showing another example of a functional configuration of an image signal processing device according to Embodiments 1 and 2; and

FIG. 16 is a block diagram showing another example of a functional configuration of the active shutter glasses according to Embodiments 1 and 2.

### DESCRIPTION OF THE PREFERRED EMBODIMENT(S)

Hereinafter, embodiments of the present invention shall be described with reference to the Drawings.

### Embodiment 1

Hereinafter, an image display system including an image signal processing device according to Embodiment 1 of the present invention shall be described with reference to the Drawings.

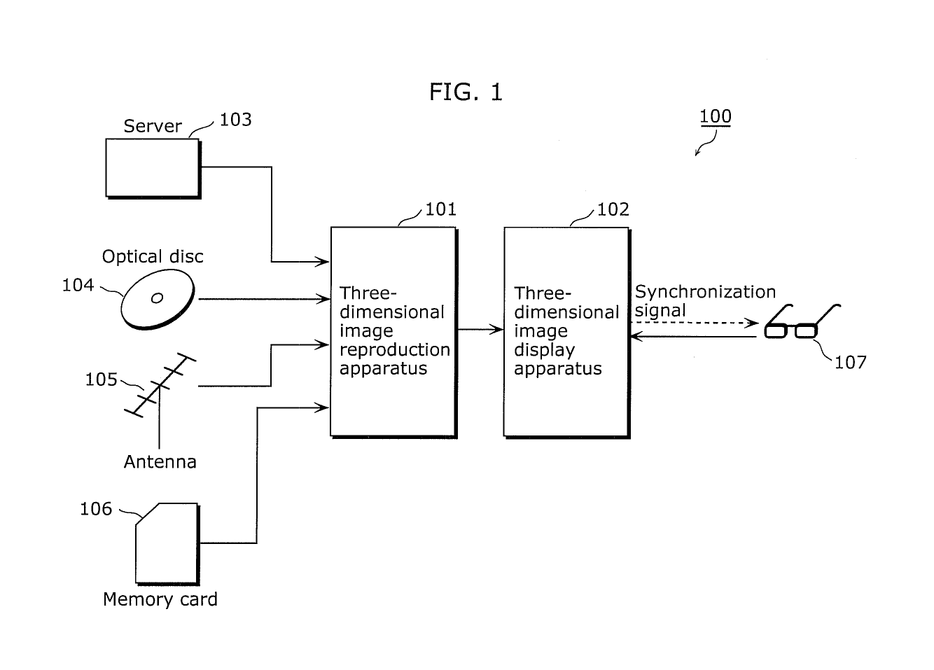

FIG. 1 is diagram showing a configuration outline of an image display system 100 according to Embodiment 1.

As shown in FIG. 1, in the image display system 100, a three-dimensional image display apparatus 102 for displaying three-dimensional images, a server 103, an optical disc 104, an antenna 105, and a memory card 106 are connected to a three-dimensional image reproduction apparatus 101.

The server 103 is a storage server in which a three-dimensional image stream is stored. The three-dimensional image reproduction apparatus 101 and the server 103 are connected via a communication network such as the Internet. The server 103 is capable of transmitting a three-dimensional image stream to the three-dimensional image reproduction apparatus 101, according to a request from the three-dimensional image reproduction apparatus 101.

The optical disc 104 is a recording medium on which a three-dimensional image stream is recorded, and can be inserted into the three-dimensional image reproduction apparatus 101. The three-dimensional image reproduction apparatus 101 is capable of reading, via a disk drive, the three-dimensional image stream recorded on the optical disc 104.

The antenna 105 is a device for receiving broadcast waves including a three-dimensional image stream transmitted from a broadcasting apparatus of a broadcast station. The broadcast waves are demodulated by a tuner, and the three-dimensional image stream obtained by demodulation is supplied to the three-dimensional image reproduction apparatus 101.

The memory card 106 is a semiconductor memory in which a three-dimensional image stream is stored, or a recoding medium provided with a semiconductor memory. The memory card 106 can be inserted into the three-dimensional image reproduction apparatus 101. The three-dimensional image reproduction apparatus 101 is capable of reading, via a memory device interface, the three-dimensional image stream stored in the memory card 106.

As a primary function, the three-dimensional image reproduction apparatus 101 decodes the three-dimensional image stream obtained from the server 103, and so on, and transmits the three-dimensional image signal obtained through the decoding to the three-dimensional image display apparatus 102.

Furthermore, the user can view three-dimensional images by watching the images displayed by the three-dimensional image display apparatus 102 using active shutter glasses 107.

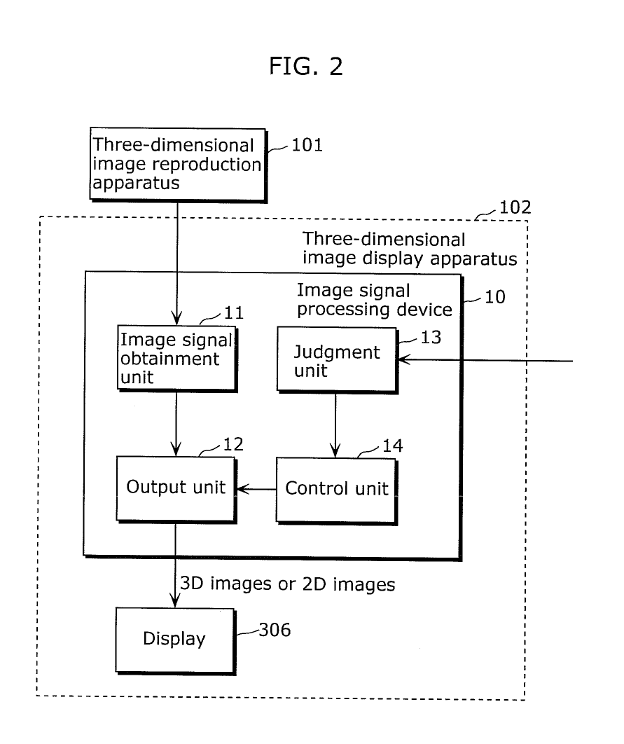

FIG. 2 is a block diagram showing a basic functional configuration of the three-dimensional image display apparatus 102 according to Embodiment 1.

As shown in FIG. 2, in Embodiment 1, an image signal processing device 10 is provided in the three-dimensional image display apparatus 102.

Specifically, in the three-dimensional image display apparatus 102, images based on a three-dimensional image signal or a two-dimensional image signal outputted from the image signal processing device 10 are displayed on a display 306.

Furthermore, the image signal processing device 10 includes an image signal obtainment unit 11, an output unit 12, a judgment unit 13, and a control unit 14.

The image signal obtainment unit 11 obtains the three-dimensional image signal for allowing three-dimensional viewing using the active shutter glasses 107. The output unit 12 outputs the three-dimensional image signal.

The judgment unit 13 judges whether or not the active shutter glasses 107 are in a valid state, based on an obtainment result for information from outside the image signal processing device 10. It should be noted that “valid state” means that the active shutter glasses 107 are in a state which allows three-dimensional viewing using the active shutter glasses 107.

When the judgment result of the judgment unit 13 indicates that the active shutter glasses 107 are not in a valid state, the control unit 14 switches the output signal from the output unit, from a three-dimensional image signal to a two-dimensional image signal associated with the three-dimensional image signal, by controlling the output unit 12.

In other words, as a basic function, the image signal processing device 10 outputs the three-dimensional image signal obtained from the three-dimensional image reproduction apparatus 101. In the case where the active shutter glasses 107 are not in the active state, the image signal processing device 10 further switches the three-dimensional image signal to, for example, a two-dimensional image signal that is generated from part of the three-dimensional image signal, or a two-dimensional image signal representing information, and the like, for notifying that the active shutter glasses 107 are not in an active state.

As a result, the display mode of the display 306 of the three-dimensional image display apparatus 102 switches from a three-dimensional display to a two-dimensional display.

It should be noted that part or all of the function blocks making up the image signal processing device 10 can be realized as one integrated circuit.

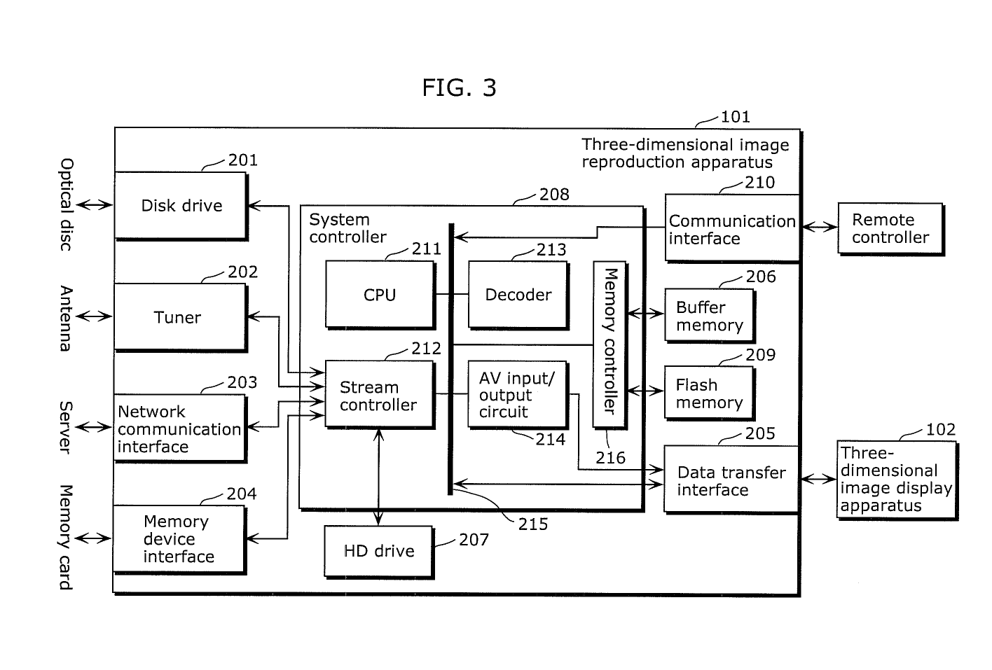

The hardware configuration of the three-dimensional image reproduction apparatus 101, the three-dimensional image display apparatus 102, and the active shutter glasses 107, which perform the above-described basic functions, shall be described using FIG. 3 to FIG. 5.

FIG. 3 is a diagram showing a basic hardware configuration of the three-dimensional image reproduction apparatus 101 according to Embodiment 1.

As shown in FIG. 3, the three-dimensional image reproduction apparatus 101 includes a disk drive 201, a tuner 202, a network communication interface 203, a memory device interface 204, a data transfer interface 205, a buffer memory 206, a hard disk (HD) drive 207, a flash memory 209, a communication interface 210, and a system controller 208. Hereinafter, basic processes performed by each of the components shall be described.

The disk drive 201 includes an optical pickup, and reads a three-dimensional image stream from the optical disc 104. The disc drive 201 is connected to the system controller 208, and transmits the three-dimensional image stream read from the optical disc 104 to the system controller 208, in response to the control by the system controller 208.

The tuner 202 demodulates broadcast waves received by the antenna 105, and transmits the three-dimensional image stream included in the broadcast waves to the system controller 208.

The network communication interface 203 receives a three-dimensional image stream transmitted from the server 103 via a communication network such as the Internet.

The memory device interface 204 is an interface for reading stored data from the memory card 106 that is inserted into the three-dimensional image reproduction apparatus 101. The memory device interface 204 transmits the three-dimensional image stream read from the memory card 106 to the system controller 208, in response to the control by the system controller 208.

The HD drive 207 is a recording device having a magnetic disk, and so on, and transmits a recorded three-dimensional image stream to the system controller 208.

The data transfer interface 205 is an interface for transmitting, to the three-dimensional image display apparatus 102, the image signal representing the images to be displayed on the three-dimensional image display apparatus 102. Furthermore, the data transfer interface 205 is an interface which allows communication between the three-dimensional image reproduction apparatus 101 and the three-dimensional image display apparatus 102.

Therefore, the system controller 208 can control the three-dimensional image display apparatus 102 via the data transfer interface 205. It should be noted that the data transfer interface 205 need not be limited to a specific configuration, as long as transmission of the image signal to the three-dimensional image display apparatus 102 is possible.

The buffer memory 206 functions as a work memory when the system controller 208 performs data processing or control. The buffer memory 206 can be realized using, for example, a DRAM or a SRAM.

The flash memory 209 is used as a memory for holding information specific to the three-dimensional image reproduction apparatus 101 and for recording the status of the three-dimensional image reproduction apparatus 101.

The communication interface 210 receives a control signal from a remote controller belonging to the three-dimensional image reproduction apparatus 101. The communication interface 210 can be realized using, for example, an interface complying with a communication standard such as infrared ray communication, Bluetooth, and so on.

The system controller 208 is a controller which performs various types of data processing and control of the respective components of the three-dimensional image reproduction apparatus 101. The system controller 208 can be realized using, for example, a microprocessor and a hard-wired circuit, and so on.

A CPU 211, a stream controller 212, a decoder 213, an AV input/output circuit 214, a system bus 215, and a memory controller 216 are provided inside the system controller 208.

The CPU 211 performs the various types of data processing and the control of the respective components that are to be performed by the system controller 208. The respective components inside the system controller 208 operate according to the control of the CPU 211.

Furthermore, the CPU 211 also performs communication with an outside device connected to the three-dimensional image reproduction apparatus 101. The CPU 211, for example, performs communication with the three-dimensional image display apparatus 102 via the data transfer interface 205.

Furthermore, the CPU 211 controls the disk drive 201, the tuner 202, the network communication interface 203, and the memory device interface 204, and obtains a three-dimensional image stream from the optical disc 104, the antenna 105, the memory card 106, and the server 103.

The stream controller 212 transfers, to respective components connected to a system bus 215, the respective three-dimensional image streams transferred from the disk drive 201, the tuner 202, the network communication interface 203, and the memory device interface 204, and the HDD drive 207. For example, the stream controller 212 transfers the three-dimensional image stream transferred from the network communication interface 203 to the buffer memory 206.

The memory controller 216 writes the data transferred from the respective components connected to the system bus 215, into the buffer memory 206 or the flash memory 209. Furthermore, the memory controller 216 transfers the data recorded on the buffer memory 206 or the flash memory 209 to the respective components connected to the system bus 215.

The decoder 213 decodes the three-dimensional image stream, and generates the images to be displayed by the three-dimensional image display apparatus 102.

The AV input/output circuit 214 superimposes secondary images such as subtitles on the images to be displayed by the three-dimensional image display apparatus 102. With this, the three-dimensional image signal or the two-dimensional to be transmitted to the three-dimensional image display apparatus 102 via the data transfer interface 205 is generated.

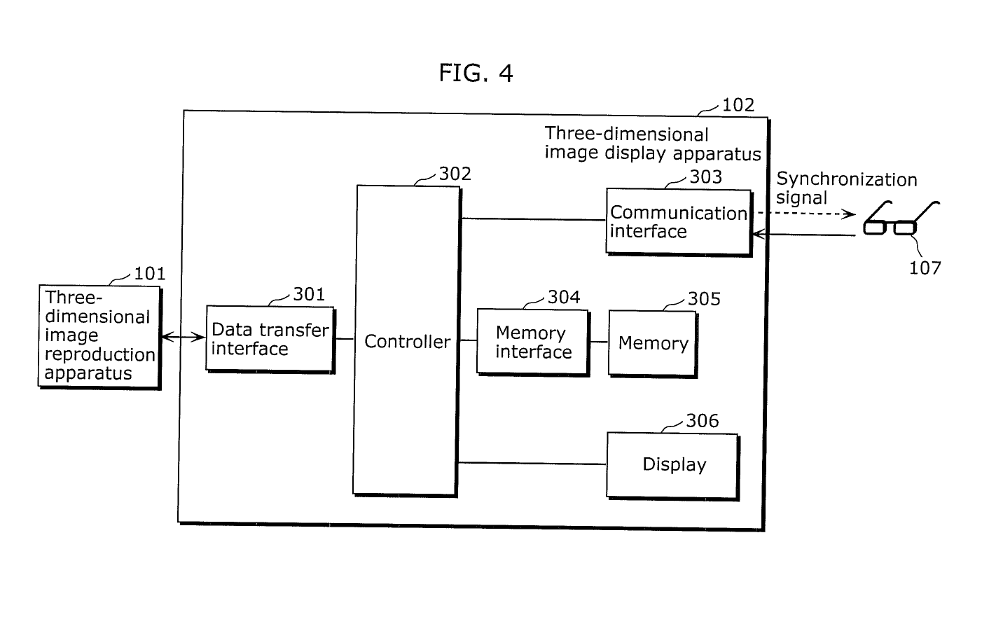

FIG. 4 is a diagram showing a basic hardware configuration of the three-dimensional image display apparatus 102 according to Embodiment 1.

The three-dimensional image display apparatus 102 (i) includes the display 306 such a liquid crystal display, a plasma display, an organic electroluminescence (EL) display, or the like, and (ii) is an apparatus which displays images.

The three-dimensional image display apparatus 102 is capable of displaying the images represented by the image signal transmitted from the three-dimensional image reproduction apparatus 101. The three-dimensional image display apparatus 102 can communicate with the active shutter glasses 107 through a communication interface 303.

Specifically, as shown in FIG. 4, the three-dimensional image display apparatus 102 includes a data transfer interface 301, a controller 302, a memory interface 304, the communication interface 303, the memory 305, and the display 306.

The data transfer interface 301 is an interface for performing transmission and reception of data with the three-dimensional image reproduction apparatus 101. The data transfer interface 301 can be realized using, for example, a High-Definition Multimedia Interface (HDMI) connector, and the like.

It should be noted that the data transfer interface 301 is an example of a component which realizes the processes of the image signal obtainment unit 11 shown in FIG. 2.

The controller 302 performs: control of the transmission and reception of data between the three-dimensional image display apparatus 102 and the three-dimensional image reproduction apparatus 101; transmission via the communication interface 303; processing of the three-dimensional image signal stored in the memory 305; control of image outputs to the display 306; and so on. The controller 302 can be realized using, for example, a microprocessor, and so on.

It should be noted that the controller 302 is an example of a component which realizes the processes of the judgment unit 13 and the control unit 14 shown in FIG. 2.

The communication interface 303 is an interface for performing communication with the active shutter glasses 107. The communication interface 303 can be realized using, for example, an interface complying with a communication standard such as infrared ray communication, Bluetooth, and so on.

Specifically, the communication interface 303 transmits a synchronization signal to the active shutter glasses 107 in response to the control by the controller 302. This synchronization signal synchronizes the switching between each of left-eye images and right-eye images to be alternately displayed on the display 306 and the alternate-blocking of the field of vision of the left eye and the field of vision for the right eye of the user in the active shutter glasses 107. As a result, the user can view three-dimensional images.

Furthermore, in the present embodiment, the communication interface 303 can receive a predetermined signal from the active shutter glasses 107. The controller 302 can judge whether or not the active shutter glasses 107 are in the valid state, depending on whether or not the communication interface 303 receives the predetermined signal from the active shutter glasses 107.

It should be noted that, the communication interface 303 can also receive a signal from the remote controller belonging to the three-dimensional image display apparatus 102.

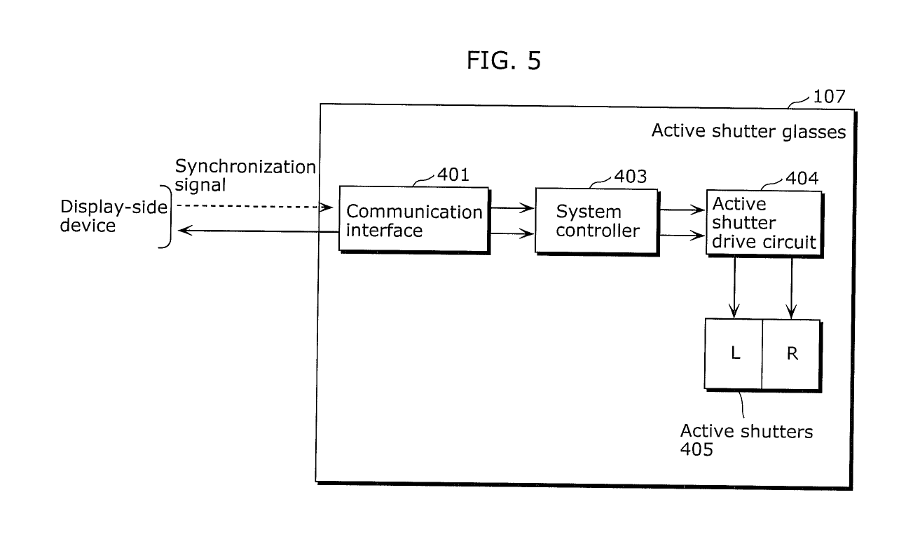

FIG. 5 is a diagram showing a basic hardware configuration of the active shutter glasses 107 according to Embodiment 1.

As shown in FIG. 5, the active shutter glasses 107 include a communication interface 401, a system controller 403, an active shutter drive circuit 404, and active shutters 405.

The communication interface 401 is an interface for performing data communication with a device on the image displaying-side. The communication interface 401 can be realized using, for example, an interface complying with a communication standard such as infrared ray communication, Bluetooth, and so on.

In the present embodiment, the communication interface 401 performs data communication with the three-dimensional image display apparatus 102. Specifically, the communication interface 401 can receive the synchronization signal from the three-dimensional image display apparatus 102, and can transmit a predetermined signal that the three-dimensional image display apparatus 102 is capable of receiving, during an operational period in which the active shutter glasses 107 perform the opening and closing operation of liquid crystal shutters described below.

The pair of active shutters 405 is a device for blocking either the left or right or both fields of vision of the user. The active shutters 405 can be realized using, for example, liquid crystal shutters, and so on.

The system controller 403 performs communication with the three-dimensional image display apparatus 102, using the communication interface 401. Furthermore, the system controller 403 performs opening and closing control on the active shutters 405 via the active shutter drive circuit 404, in accordance with the synchronization signal transmitted from the three-dimensional image display apparatus 102. The system controller 403 can be realized using, for example, a microprocessor, and so on.

The basic flow of operations performed by the image display system 100 having the configuration described above shall be described hereinafter.

When connected to the three-dimensional image display apparatus 102, the three-dimensional image reproduction apparatus 101 obtains, from the three-dimensional image display apparatus 102, three-dimensional image displayability information and information such as the displayable screen size, and so on. The three-dimensional image reproduction apparatus 101 stores the obtained information in the buffer memory 206.

The system controller 208 transfers, for example, the three-dimensional image stream read from the optical disc 104 inserted in the disk drive 201 to memory controller 216, via the system bus 215.

The memory controller 216 stores the transferred three-dimensional image stream in the buffer memory 206. The system controller 208 transfers the three-dimensional image stream, from the buffer memory 206 to the decoder 213. Furthermore, the system controller 208 transfers the decoded three-dimensional image stream, from the decoder 213 to the buffer memory 206.

With this, the three-dimensional image signal to be displayed by the three-dimensional image display apparatus 102 is stored in the buffer memory 206. The three-dimensional image signal includes an image signal representing images to be projected only to the left eye of the user, and an image signal representing images to be projected only to the right eye of the user.

When the three-dimensional image displayability information obtained when the three-dimensional image reproduction apparatus 101 is connected to the three-dimensional image display apparatus 102 indicates that display of three-dimensional images is possible, the three-dimensional image reproduction apparatus 101 transmits the entirety of the three-dimensional image signal to the three-dimensional image display apparatus 102 via the data transfer interface 205.

The controller 302 of the three-dimensional image display apparatus 102 transfers, to the memory interface 304, the three-dimensional image signal received by the data transfer interface 301 from the three-dimensional image reproduction apparatus 101.

The memory interface 304 stores the transferred three-dimensional image signal in the memory 305. With this, the left-eye images and the right-eye images represented by the three-dimensional image signal are stored in the memory 305.

The controller 302 performs data transfer according to a display setting for the display 306 which is set by the user. Specifically, when a three-dimensional image display setting is active, the controller 302 transfers all of the left-eye images and the right-eye images stored in the memory 305 to the display 306.

At the same time, the controller 302 requests the blocking of the right-eye field of view to the active shutter glasses 107 via the communication interface 303 when an image to be projected to the left eye of the user (left-eye image) is displayed on the display 306, and requests the blocking of the left-eye field of view when an image to be projected to the right eye of the user (right-eye image) is displayed on the display 306.

Specifically, the synchronization signal representing these requests is transmitted from the communication interface 303 to the active shutter glasses 107.

It should be noted that whether or not the three-dimensional image display setting is active need not depend on the display setting for the display 306 set by the user. For example, whether or not the three-dimensional image display setting of the three-dimensional image display apparatus 102 is active can be determined based on a request from the three-dimensional image reproduction apparatus 101.

The system controller 403 of the active shutter glasses 107 receives from the three-dimensional image display apparatus 102, via the communication interface 401, the synchronization signal representing the request to block the field of vision of the left eye, the right eye, or both eyes of the user. The system controller 403 controls the active shutter drive circuit 404 according to the synchronization signal, and performs the opening and closing control of the respective active shutters 405 for the left eye and the right eye.

With this series of operations, the user wearing the active shutter glasses 107 is able to view three dimensional images by watching, almost simultaneously using the left eye and right eye, left-eye images and right-eye images that differ only by the respective parallaxes of the left eye and the right eye.

Here, a situation is assumed in which the field of vision of the left eye or the right eye of the user cannot be blocked at the appropriate timing even when the display 306 of the three-dimensional image display apparatus 102 is displaying three-dimensional images, such as when the user is not wearing the active shutter glasses 107.

In this case, the user views the images to be projected only to the left eye or the right eye using both left and right eyes, and thus the problem of not being able to view clear images occurs as a result.

The image display system 100 according to Embodiment 1 is capable of suppressing the occurrence of such a problem.

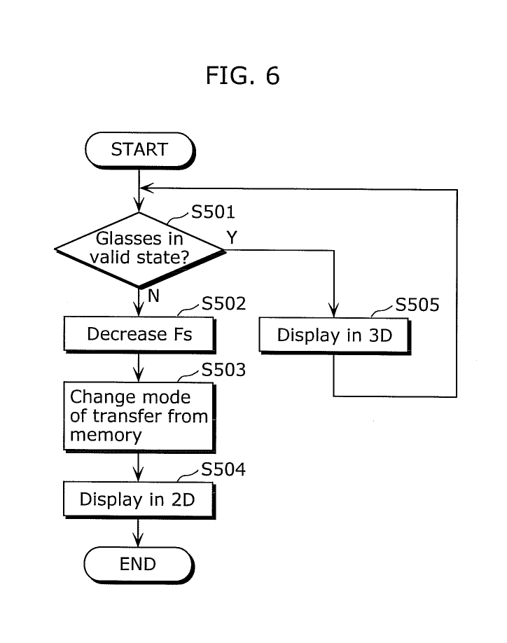

The specific processes performed by the three-dimensional image display apparatus 102 for suppressing the occurrence such a problem shall be described using FIG. 6.

FIG. 6 is a flowchart showing a first example of the flow of processes performed by the three-dimensional image display apparatus 102 according to Embodiment 1.

The three-dimensional image display apparatus 102 judges the presence of valid active shutter glasses 107, via the communication interface 303. For example, when the subject for judgment is only one pair of active shutter glasses 107, the three-dimensional image display apparatus 102 judges whether or not such active shutter glasses 107 are in the valid state (S501).

In the present embodiment, the controller 302 of the three-dimensional image display apparatus 102 judges whether or not the active shutter glasses 107 are in the valid state, depending on whether or not a predetermined signal transmitted, on a fixed time period basis, from the communication interface 401 of the active shutter glasses 107 by way of one-way communication such as infrared rays is received by the communication interface 303 on such fixed time period basis.

For example, the controller 302 judges that the active shutter glasses 107 are not in the valid state when the communication interface 303 does not receive the predetermined signal for a predetermined period of time.

Specifically, the controller 302 judges that the active shutter glasses 107 are not in the valid state when the power source of the active shutter glasses 107 is OFF or when the active shutter glasses 107 are not facing the screen (display 306) and the predetermined signal transmitted by way of infrared rays does not reach the communication interface 303, and so on.

It should be noted that the method for such judgment is not limited to the above-described method. For example, a case is assumed in which two-way communication devices using Bluetooth, and so on, are adopted as the communication interface 303 of the three-dimensional image display apparatus 102 and the communication interface 401 of the active shutter glasses 107.

In this case, by transmitting an inquiry signal from the communication interface 303 to the communication interface 401, it is possible to cause the communication interface 401 to return the predetermined signal as a response to the inquiry signal.

Specifically, the three-dimensional image display apparatus 102 can make an inquiry to the active shutter glasses 107 at an as-needed timing, and judge that the active shutter glasses 107 are not in the valid state when there is no response to the inquiry.

When the presence of active shutter glasses 107 in the valid state (hereinafter also denoted simply as “valid active shutter glasses 107”) is confirmed (Y in S501), the three-dimensional image display apparatus 102 continues the three-dimensional image display (S505). When the presence cannot be confirmed (N in S501), the controller 302 changes the display refresh cycle (denoted as “Fs” in the figure) of the display 306 to 0.5-fold (S502).

For example, in the case of displaying 24 frames per second of a movie content on the display 306, it is necessary to alternately display left-eye images and right-eye images 24 times each per second. For this reason, the display refresh cycle of the display 306 is 48 Hz. However, when valid active shutter glasses 107 cannot be detected, the controller 302 changes this display refresh cycle to 24 Hz.

At the same time, the controller 302, performs control to transfer, to the display 306, either the left-eye images only or the right-eye images only, out of the left-eye images and the right-eye images stored in the memory 305 (S503).

With this, the user can view, using both left and right eyes, two-dimensional (2D) images composed of the left-eye images only or the right-eye images only, in the same manner as when not wearing the active shutter glasses 107 (S504).

In other words, the image display mode in the display 306 can be switched from three-dimensional to two-dimensional when the communication interface 303 of the three-dimensional image display apparatus 102 does not receive the predetermined signal transmitted by way of infrared rays from the active shutter glasses 107 due to, for example, the active shutter glasses 107 being taken off from the user regardless of whether intended or not intended by the user.

Furthermore, the same is true, for example, in the case where the opening and closing operation of the active shutters 405 stop due to the active shutter glasses 107 running out of battery. Specifically, since the communication interface 303 of the three-dimensional image display apparatus 102 does not receive the predetermined signal from the active shutter glasses 107, the image display mode in the display 306 is switched from the three-dimensional image display to the two-dimensional image display.

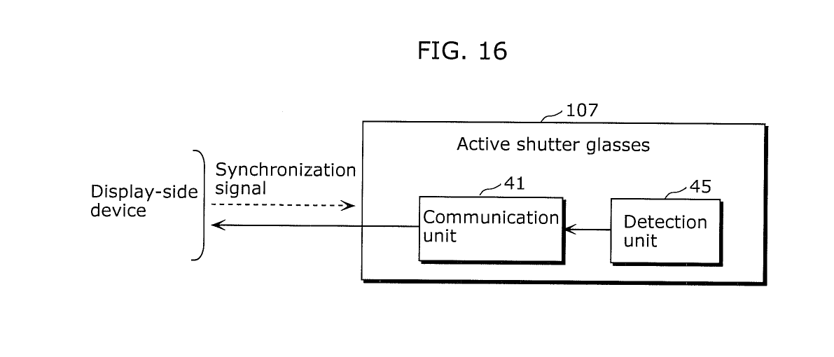

It should be noted that the active shutter glasses 107 may include a detection unit which detects information concerning whether or not the active shutter glasses 107 are in the valid state, and whether or not to transmit the predetermined signal may be determined according to the detection result from the detection unit. Such a detection unit shall be described later using FIG. 16.

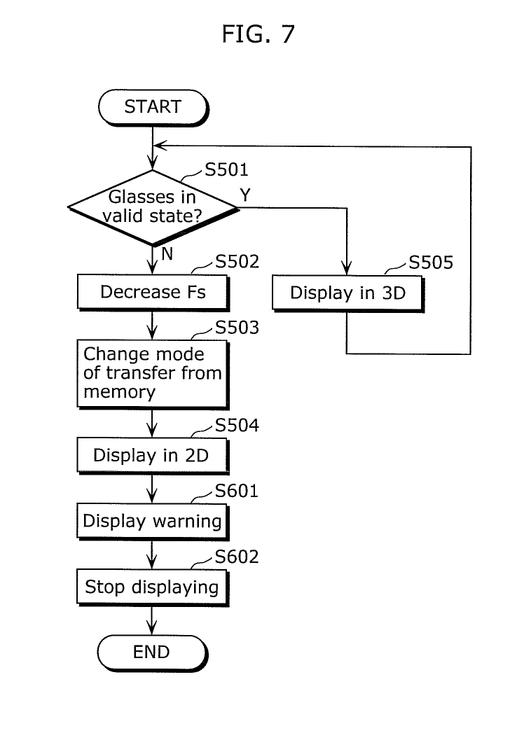

FIG. 7 is a flowchart showing a first example of the flow of processes performed by the three-dimensional image display apparatus 102 according to Embodiment 1.

It should be noted that the respective processes from S501 to S504 in FIG. 7 are the same as in FIG. 6.

Here, it is possible to judge the active shutter glasses 107 as not being valid due to the user forgetting to wear the active shutter glasses 107 or to a battery run-out of the active shutter glasses 107 that is not intended by the user.

In view of this, after the switching to the two-dimensional image display onward (S504), the controller 302 displays, by superimposition on the images displayed on the display 306, a warning message indicating the occurrence of a state caused by the active shutter glasses 107 not being in the valid state (S601).

It should be noted that the warning message is an example of an image based on the two-dimensional image signal associated with the three-dimensional image signal, and is generated by, for example, the controller 302 functioning as the control unit 14. Furthermore, the warning message is exemplified by text information such as “unable to confirm valid active shutter glasses”, “3D image display stopped”, and so on.

Furthermore, the controller 302 causes the display of the two-dimensional images (except for the warning message) to stop (S602).

Furthermore, the display of the two-dimensional images including the warning message may be stopped when a predetermined period of time has elapsed from when the warning message was displayed.

Furthermore, the controller 302 may stop the display of images on the display 306 by instructing the stoppage of three-dimensional image transmission to the three-dimensional image reproduction apparatus 101 which is the source device of the images to be displayed.

For example, the three-dimensional image display apparatus 102 requests for the pausing of the reproduction to the three-dimensional image reproduction apparatus 101, via the data transfer interface 301. The system controller 208 of the three-dimensional image reproduction apparatus 101 which has received the pause request suspends the transfer of the three-dimensional image stream from the transmission source of the three-dimensional image stream to the memory controller 216.

The system controller 208, in addition, suspends the transfer of the three-dimensional image stream from the memory controller 216 to the decoder 213, or suspends the transfer of the three-dimensional image signal from the memory controller 216 to the data transfer interface 205.

With this, the display of images other than the warning message, on the display 306, is stopped.

Furthermore, the warning message may be generated by the three-dimensional image reproduction apparatus 101.

Specifically, after switching to the two-dimensional image display (S504), the three-dimensional image display apparatus 102 requests for the pausing of the reproduction to the three-dimensional image reproduction apparatus 101, via the data transfer interface 301. The three-dimensional image reproduction apparatus 101 which has received the pause request generates a three-dimensional image signal such that the warning message indicating the occurrence of a state caused by the active shutter glasses 107 not being in the valid state is displayed by being superimposed on the three-dimensional images stored in the buffer memory 206 (S601).

In this case, the three-dimensional image display apparatus 102 receives the three-dimensional image signal including the warning message, and displays, on the display 306, only the right-eye images or the left-eye images represented by the three-dimensional image signal. In other words, two-dimensional images including the warning message are displayed on the display 306.

Subsequently, for example, after the lapse of a predetermined period of time, the system controller 208 may suspend the transfer of the three-dimensional image stream from the transmission source of the three-dimensional image stream to the memory controller 216, and suspend the transfer of the three-dimensional image stream from the memory controller 216 to the decoder 213 or the transfer of the three-dimensional image signal from the memory controller 216 to the data transfer interface 205.

In this case, in the display 306, all display of images including the warning message is stopped.

It should be noted that the warning indicating the occurrence of a state caused by the active shutter glasses 107 not being in the valid state may be notified to the user using a method other than being superimposed on a two-dimensional image generated from part of the three dimensional image signal. For example, although not illustrated, the warning may be notified to the user by way of the flickering of an indicator lamp provided in the three-dimensional image reproduction apparatus 101 which has received the pause request or the three-dimensional image display apparatus 102, or by sound from a speaker, and so on.

Furthermore, the method of switching from three-dimensional image display to two-dimensional image display when valid active shutter glasses 107 cannot be confirmed is not limited to the method shown in FIG. 6 and FIG. 7.

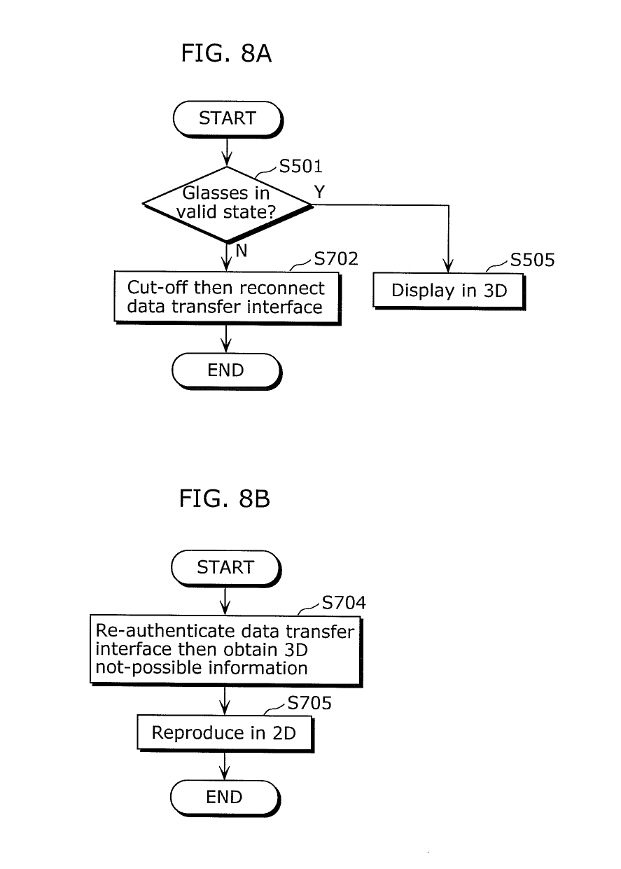

For example, it is also acceptable to switch from three-dimensional image display to two-dimensional image display, according to the process flow shown in FIG. 8A or FIG. 8B.

FIG. 8A is a flowchart showing an example of the flow of processes related to the switching of image display modes, performed by the three-dimensional image display apparatus 102 according to Embodiment 1.

FIG. 8A is a flowchart showing an example of the flow of processes related to the switching of image display modes, performed by the three-dimensional image reproduction apparatus 101 according to Embodiment 1.

As shown in FIG. 8A, when valid active shutter glasses 107 are confirmed (Y in S501) as a result of the judgment process (S501) of whether or not the active shutter glasses 107 are valid, the controller 302 of the three-dimensional image display apparatus 102 causes the continuation of the three-dimensional image display (S505). Up to this point, details are the same as described in FIG. 6.

Furthermore, when the presence of valid active shutter glasses 107 cannot be confirmed (N in S501), the controller 302 of the three-dimensional image display apparatus 102 performs control to temporarily cut-off and then reconnect the data transfer interface 301 (S702).

Furthermore, when the three-dimensional image display apparatus 102 reconnects with the three-dimensional image reproduction apparatus 101, the three-dimensional image reproduction apparatus 101 requests the three-dimensional image display apparatus 102 for three-dimensional image displayability information. The three-dimensional image display apparatus 102 responds to this request with information indicating that three-dimensional image display is not possible.

As a result, as shown in FIG. 8B, after such reconnection, the three-dimensional image reproduction apparatus 101 obtains such information from the three-dimensional image display apparatus 102 (S704).

The system controller 208 of the three-dimensional image reproduction apparatus 101 transmits a two-dimensional image signal from the data transfer interface 205 (S705). Specifically, the system controller 208 changes the setting of the decoder 213 such that only the left-eye images or the right-eye images are decoded from the three-dimensional image stream.

Alternatively, without changing the setting in which the decoder 213 decodes both the left- and right-eye images, the system controller 208 changes the setting for the data transfer from the buffer memory 206 where both left- and right-eye images are stored to the data transfer interface 205, such that only the left-eye images or only the right-eye images are transferred.

With this, the user can view two-dimensional (2D) images composed of the left-eye images only or the right-eye images only, using both left and right eyes, in the same manner as when not wearing the active shutter glasses 107.

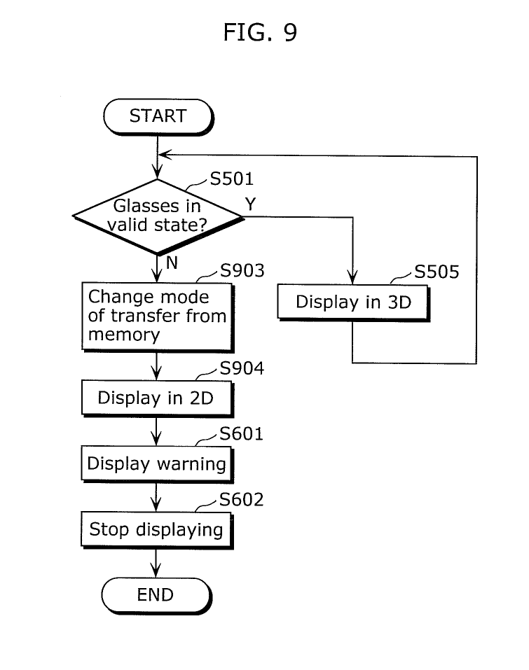

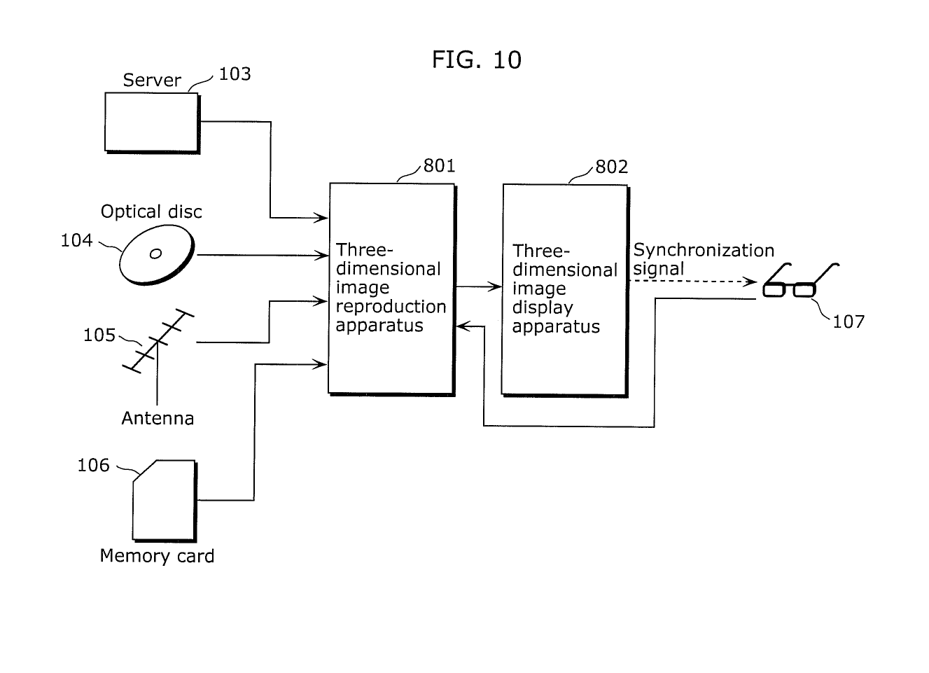

Furthermore, the switching from three-dimensional image display to two-dimensional image display when valid active shutter glasses 107 cannot be confirmed may be executed according to the process flow shown in FIG. 9.

FIG. 9 is a flowchart showing a third example of the flow of processes performed by the three-dimensional image display apparatus 102 according to Embodiment 1.

As shown in FIG. 9, when valid active shutter glasses 107 is confirmed (Y in S501) as a result of the judgment process (S501) of whether or not the active shutter glasses 107 are valid, the controller 302 of the three-dimensional image display apparatus 102 causes the continuation of the three-dimensional image display (S505). Up to this point, details are the same as described in FIG. 6.

Furthermore, when the presence of valid active shutter glasses 107 cannot be confirmed (N in S501), the controller 302 of the three-dimensional image display apparatus 102 performs control to transfer, to the display 306, either the left-eye images only or the right-eye images only, out of the left-eye images and the right-eye images stored in the memory 305, by repeating each image twice (S903).

For example, in the case of reproducing 24 frames per second of a movie content, it is necessary to display left-eye images and right-eye images 24 times each per second. As such, when three-dimensional image display is performed, the left-eye images (L1, L2, L3, . . . ) and the right-eye images (R1, R2, R3, . . . ) stored in the memory 305 are transferred as L1, R1, L2, R2, . . . .

However, when valid active shutter glasses 107 cannot be confirmed, the controller 302 changes to a control for transferring only the left-eye images in an L1, L1, L2, L2, L3, . . . sequence, or to a control for transferring only the right-eye images in an R1, R1, R2, R2, R3, . . . sequence.

With this, the user can view two-dimensional (2D) images composed of the left-eye images only or the right-eye images only, using both left and right eyes, in the same manner as when not wearing the active shutter glasses 107 (S904).

It should be noted that the displaying of the warning (S601) and the stopping of the display of images (S602) may be executed subsequently, as shown in FIG. 9. Specifically, in the same manner as in FIG. 7, the displaying of a warning message indicating the occurrence of a state caused by the active shutter glasses 107 not being in the valid state (S601), and the stopping of the display of two-dimensional images other than the warning message or two-dimensional messages including the warning message (S602) may be executed.

### Embodiment 2

Hereinafter, an image display system 800 including a three-dimensional image reproduction apparatus 801 and a three-dimensional image display apparatus 802 shall be described with reference to the Drawings.

FIG. 10 is diagram showing a configuration outline of an image display system 800 according to Embodiment 2.

It should be noted that in FIG. 10 and the respective Drawings to be described later, components that are in common with Embodiment 1 are given the same numerical references and detailed description thereof shall not be repeated here.

As shown in FIG. 10, in the image display system 800, the three-dimensional image display apparatus 802 for displaying three-dimensional images, the server 103, the optical disc 104, the antenna 105, and the memory card 106 are connected to the three-dimensional image reproduction apparatus 801.

In other words, the overall configuration of the image display system 800 is the same as the image display system 100 in Embodiment 1. Furthermore, the point in which the three-dimensional image stream obtained from the server 103, and so on, is decoded by the three-dimensional image reproduction apparatus 801, and the three-dimensional images obtained through the decoding are displayed by the three-dimensional image display apparatus 802 is the same as in Embodiment 1. In addition, the point of the user viewing three-dimensional images using active shutter glasses 107 is the same as in Embodiment 1.

However, Embodiment 2 is different from Embodiment 1 with regard to the point that the image signal processing device 10 which performs the judgment of whether or not the active shutter glasses 107 are in the valid state, and so on, is provided in the three-dimensional image reproduction apparatus 801 instead of the three-dimensional image display apparatus 802. In view of this, description shall be carried out focusing on the points of difference.

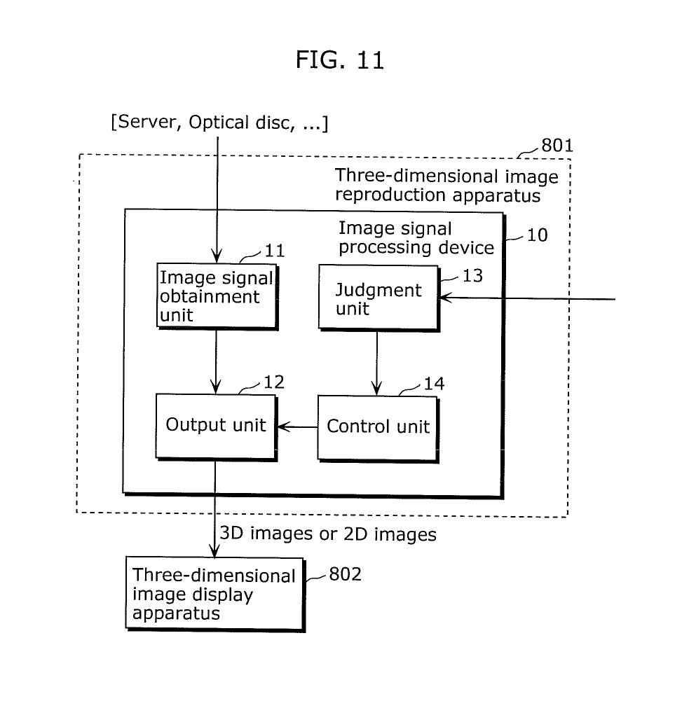

FIG. 11 is a block diagram showing a basic functional configuration of the three-dimensional image reproduction apparatus 801 according to Embodiment 2.

As shown in FIG. 11, in Embodiment 2, the image signal processing device 10 is provided in the three-dimensional image reproduction apparatus 801.

In the image signal processing device 10 according to Embodiment 2, the image signal obtainment unit 11 obtains an image stream including a three-dimensional image signal, from the server, and so on. Specifically, the output unit 12 outputs a three-dimensional image signal or a two-dimensional image signal to the three-dimensional image display apparatus 802.

Furthermore, the operations of the judgment unit 13 and the control unit 14 are the same as in Embodiment 1. Specifically, the judgment unit 13 judges whether or not the active shutter glasses 107 are in a valid state, based on an obtainment result for information from outside the image signal processing device 10.

When the judgment result of the judgment unit 13 indicates that the active shutter glasses 107 are not in a valid state, the control unit 14 switches the output signal from the output unit, from a three-dimensional image signal to a two-dimensional image signal associated with the three-dimensional image signal, by controlling the output unit 12.

As a result, the display mode of the display 306 of the three-dimensional image display apparatus 102 switches from a three-dimensional display to a two-dimensional display.

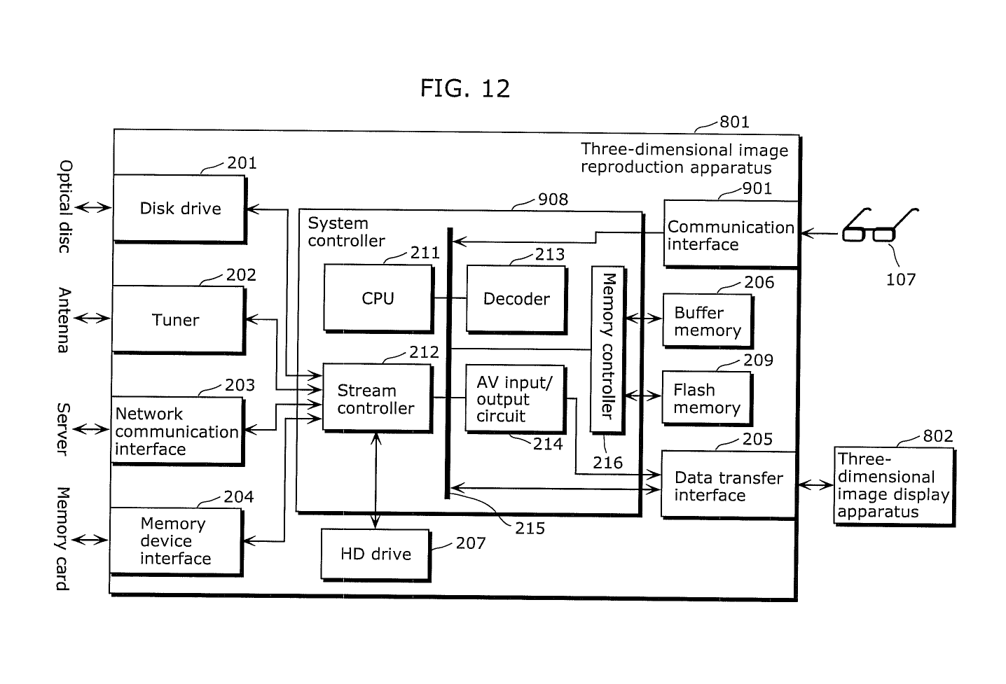

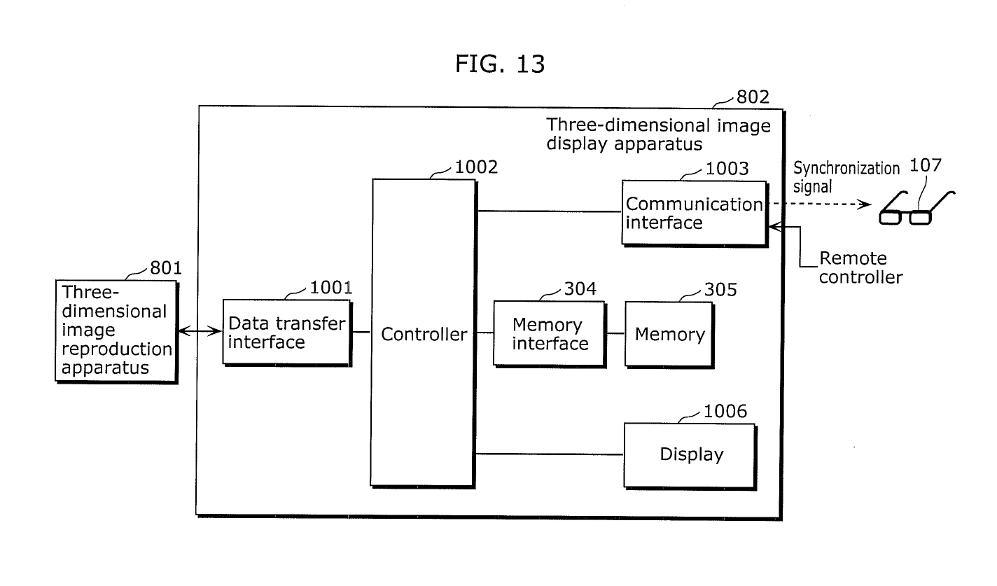

The hardware configuration of the three-dimensional image reproduction apparatus 801 and the three-dimensional image display apparatus 802 which perform the above-described basic operations shall be described using FIG. 12 and FIG. 13, centering on the differences from the three-dimensional image reproduction apparatus 101 and the three-dimensional image display apparatus 102 according to Embodiment 1.

FIG. 12 is a diagram showing a basic hardware configuration of the three-dimensional image reproduction apparatus 801 according to Embodiment 2.

As shown in FIG. 12, the three-dimensional image reproduction apparatus 801 has the same hardware configuration as the three-dimensional image reproduction apparatus 101 according to Embodiment 1.

However, the point that a system controller 908 functions as the image signal processing device 10 is different from the system controller 208 according to Embodiment 1.

Specifically, the stream controller 212 is an example of a component which realizes the processes of the image signal obtainment unit 11 shown in FIG. 11.

Furthermore, the AV input/output circuit 214 is an example of a component which realizes the processes of the output unit 12 shown in FIG. 11.

Furthermore, the CPU 211 is an example of a component which realizes the processes of the judgment unit 13 and the control unit 14 shown in FIG. 11.

Furthermore, a communication interface 901 receives a control signal from a remote controller belonging to the three-dimensional image reproduction apparatus 801, in the same manner as the communication interface 210 according to Embodiment 1.

The communication interface 901 can, in addition, receive a predetermined signal transmitted by way of infrared rays or Bluetooth, from the active shutter glasses 107. It should be noted that, the communication interface 901 may receive the predetermined signal transmitted from the active shutter glasses 107, via the three-dimensional image display apparatus 802.

Specifically, in Embodiment 2, the CPU 211 judges whether or not the active shutter glasses 107 are valid, depending on whether or not the communication interface 901 receives the predetermined signal from the active shutter glasses 107.

For example, the CPU 211 judges that the active shutter glasses 107 are not in the valid state when the communication interface 901 does not receive the predetermined signal for a predetermined period of time.

Furthermore, as in Embodiment 1, the judgment method is not limited to the above-described method. For example, the CPU 211 may judge that the active shutter glasses 107 are not in the valid state when the predetermined signal serving as a response to an inquiry signal from the communication interface 901 is not received from the active shutter glasses 107.

In addition, since the basic processes related to the generation of the three-dimensional image signal executed by the three-dimensional image reproduction apparatus 801 are the same as those of the three-dimensional image reproduction apparatus 101 in Embodiment 1, detailed description thereof shall not be repeated here.

FIG. 13 is a diagram showing a basic hardware configuration of the three-dimensional image display apparatus 802 according to Embodiment 2.

The three-dimensional image display apparatus 802 according to Embodiment 2 has the same basic hardware configuration as the three-dimensional image display apparatus 102 according to Embodiment 1. Specifically, the three-dimensional image display apparatus 802 (i) includes a display 1006 such as a liquid crystal display, a plasma display, an organic electroluminescence (EL) display, or the like, and (ii) is an apparatus which displays images.

Furthermore, the three-dimensional image display apparatus 802 is capable of displaying the images represented by the image signal transmitted from the three-dimensional image reproduction apparatus 801.

Furthermore, the three-dimensional images displayed on the display 1006 can be viewed three-dimensionally using the active shutter glasses 107.

The three-dimensional image display apparatus 802 can communicate with the active shutter glasses 107 through a communication interface 1003. Here, in Embodiment 2, since the judgment as to whether or not the active shutter glasses 107 are valid is performed by the three-dimensional image reproduction apparatus 801 as described above, the three-dimensional image reproduction apparatus 801 has a function of receiving the predetermined signal from the active shutter glasses 107.

As such, the communication interface 1003 of the three-dimensional image display apparatus 802 does not need to have the function of receiving the predetermined signal from the active shutter glasses 107. Therefore, the communication interface 1003 has, for example, only the function of receiving a signal from the remote controller belonging to the three-dimensional image display apparatus 802.

Furthermore, a data transfer interface 1001 and a controller 1002 differ from the data transfer interface 301 and the controller 302 with regard to the point of not having to perform the processes as the image signal processing device 10.

In addition, since the basic processes related to the displaying of images executed by the three-dimensional image display apparatus 802 are the same as those of the three-dimensional image display apparatus 102 in Embodiment 1, detailed description thereof shall not be repeated here.

Furthermore, the basic hardware configuration of the active shutter glasses 107 according to Embodiment 2 is the same as that of the active shutter glasses 107 in Embodiment 1, and includes a configuration for transmitting the predetermined signal during the operational period of the active shutter glasses 107. Therefore, the basic hardware configuration of the active shutter glasses 107 shall not be repeated here.

Furthermore, the basic flow of processes related to the displaying of three-dimensional images in the image display system 800 is the same as in Embodiment 1.

Specifically, the three-dimensional image reproduction apparatus 801 generates a three-dimensional image signal according to three-dimensional image displayability information and information such as the displayable screen size which are obtained at the time of connection with the three-dimensional image display apparatus 802, and transmits the three-dimensional image signal to the three-dimensional image display apparatus 802.

The three-dimensional image display apparatus 802 which has received the three-dimensional image signal checks the display setting which complies with a request from, for example, the user, the three-dimensional image reproduction apparatus 801, and so on, and displays all of the left-eye images and the right-eye images on the display 1006 when the three-dimensional image display setting is active. Furthermore, in this case, the three-dimensional image display apparatus 802 transmits the synchronization signal to the active shutter glasses 107 to synchronize the switching between the left-eye images and right-eye images in the display 1006 and the opening and closing of the active shutters 405.

The active shutter glasses 107 perform the opening and the closing of the active shutters 405 to alternately block the field of vision of the left eye and the field of vision of the right eye, in accordance with the received synchronization signal.

With this series of operations, the user wearing the active shutter glasses 107 is able to view three dimensional images by watching, almost simultaneously using the left eye and right eye, left-eye images and right-eye images that differ only by the respective parallaxes of the left eye and the right eye.

Here, a situation is assumed in which the field of vision of the left eye or the right eye of the user cannot be blocked at the appropriate timing even when the display 1006 of the three-dimensional image display apparatus 802 is displaying three-dimensional images, such as when the user is not wearing the active shutter glasses 107.

In this case, the user views the images to be projected only to the left eye or the right eye using the both left and right eyes, and the problem of not being able to view clear images occurs as a result.

The image display system 800 according to Embodiment 2 is capable of suppressing the occurrence of such a problem.

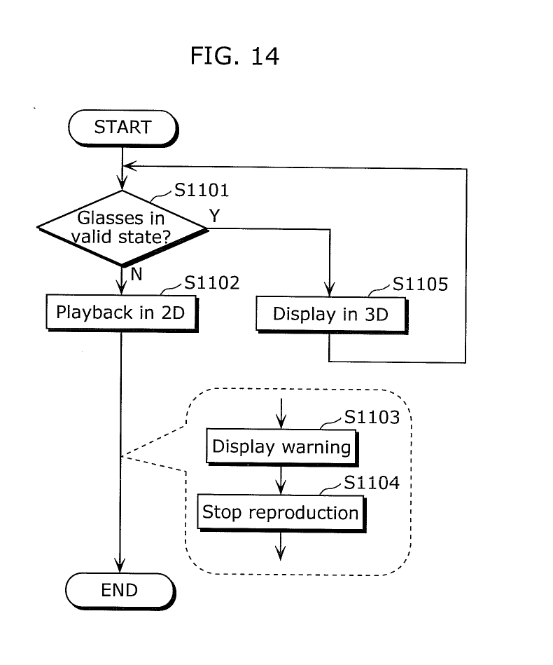

The specific processes performed by the three-dimensional image reproduction apparatus 801 for suppressing the occurrence such a problem shall be described using FIG. 14.

FIG. 14 is a flowchart showing an example of the flow of processes performed by the three-dimensional image reproduction apparatus 801 according to Embodiment 2.

The three-dimensional image reproduction apparatus 801 judges the presence of valid active shutter glasses 107, through the communication interface 901. For example, when the subject for judgment is only one pair of active shutter glasses 107, the three-dimensional image reproduction apparatus 801 judges whether or not these active shutter glasses 107 are in the valid state (S1101).

In the present embodiment, the system controller 908 of the three-dimensional image reproduction apparatus 801 judges whether or not the active shutter glasses 107 are in the valid state, depending on whether or not a predetermined signal transmitted, on a fixed time period basis, from the communication interface 401 of the active shutter glasses 107 by way of one-way communication such as infrared rays is received by the communication interface 901 on such fixed time period basis.

For example, the system controller 908 judges that the active shutter glasses 107 are not in the valid state when the communication interface 901 does not receive the predetermined signal for a predetermined period of time.

It should be noted that the method for such judgment is not limited to the above-described method. For example, a case is assumed in which two-way communication devices for Bluetooth, and so on, are adopted as the communication interface 901 of the three-dimensional image reproduction apparatus 801 and the communication interface 401 of the active shutter glasses 107.

In this case, by transmitting an inquiry signal from the communication interface 901 to the communication interface 401, it is possible to cause the communication interface 401 to return the predetermined signal as a response to the inquiry signal.

Specifically, three-dimensional image reproduction apparatus 801 can also make an inquiry to the active shutter glasses 107 at an as-needed timing, and judge whether or not the active shutter glasses 107 are valid depending on whether or not there is a response to the inquiry.

When the presence of active shutter glasses 107 is confirmed (Y in S1101), the three-dimensional image reproduction apparatus 801 continues the displaying of three-dimensional images (S1105). When the presence cannot be confirmed (N in S1101), the system controller 908 performs control to transmit a two-dimensional image signal from the data transfer interface 205.

Specifically, the system controller 908 changes the setting of the decoder 213 such that only the left-eye images or the right-eye images are decoded from the three-dimensional image stream.

Alternatively, without changing the setting of decoding both the left- and right-eye images, the system controller 908 changes the setting for the data transfer from the buffer memory 206 where both left- and right-eye images are stored to the data transfer interface 205, such that only the left-eye images or only the right-eye images are transferred.

With this, the user can view two-dimensional (2D) images composed of the left-eye images only or the right-eye images only, using both left and right eyes, in the same manner as when not wearing the active shutter glasses 107 (S1102).

It should be noted that it is possible to judge the active shutter glasses 107 as not being valid due to the user forgetting to wear the active shutter glasses 107 or a battery run-out of the active shutter glasses 107 that is not intended by the user.

In view of this, after the switching to the two-dimensional image display onward (S1102), the system controller 908 may generate the three-dimensional signal such that a warning message indicating the occurrence of a state caused by the active shutter glasses 107 not being in the valid state is displayed by superimposition on the left-eye images or the right-eye images stored in the buffer memory 206 (S1103).

It should be noted that the three-dimensional image display apparatus 802 may be caused to generate the warning message. In this case, by instructing the three-dimensional image display apparatus 802, the three-dimensional image reproduction apparatus 801 may cause the three-dimensional image display apparatus 802 to display the warning message and the images generated by the three-dimensional image reproduction apparatus 801 by superimposition.

Furthermore, for example, after the lapse of a predetermined period of time, the system controller 908 may suspend the transfer of the three-dimensional image stream from the transmission source of the three-dimensional image stream to the memory controller 216, and suspend the transfer of the three-dimensional image stream from the memory controller 216 to the decoder 213 or the transfer of two-dimensional image signal from the memory controller 216 to the data transfer interface 205 (S1104).

### Supplement to Embodiments 1 and 2

As described above, in Embodiments 1 and 2, the device on the image displaying-side (the three-dimensional image display apparatus 102 or the three-dimensional image reproduction apparatus 801) includes the image signal processing device 10. Furthermore, the image signal processing device 10 operates such that the image display mode is switched from three-dimensional image display to two-dimensional image display, when the predetermined signal from the active shutter glasses 107, which is information from outside the image signal processing device 10, is not received.

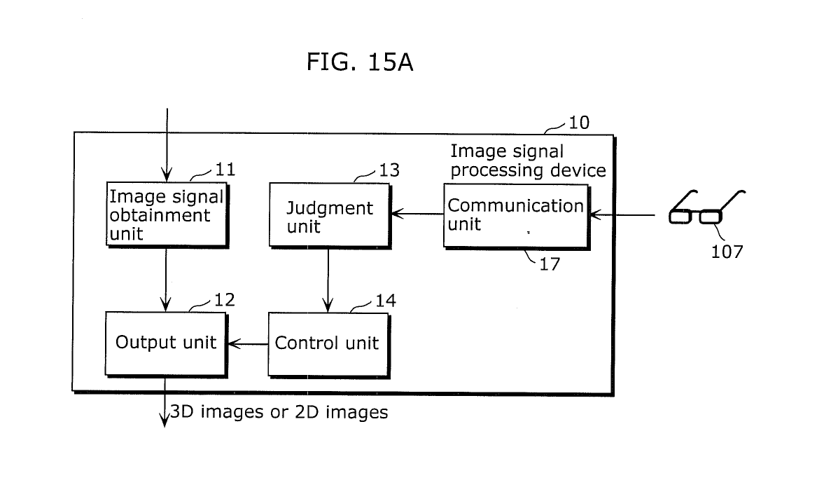

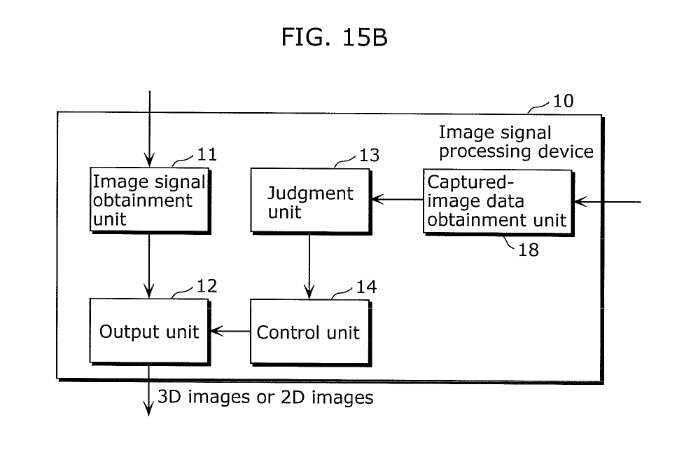

Therefore, the functional configuration of the image signal processing device 10 can be represented, for example, as in FIG. 15A.

FIG. 15A is a block diagram showing an example of a functional configuration of the image signal processing device 10 according to Embodiments 1 and 2.

As shown in FIG. 15A, the image signal processing device 10 includes a communication unit 17, in addition to the components shown in FIG. 2 and FIG. 11.

The communication unit 17 is capable of receiving the predetermined signal from the active shutter glasses 107 which is information from outside the image signal processing device 10. The communication unit 17 can be realized, for example, using the communication interface 303 of the three-dimensional image display apparatus 102 according to Embodiment 1. Furthermore, the communication unit 17 can be realized, for example, using the communication interface 901 of the three-dimensional image reproduction apparatus 801 according to Embodiment 2.

In the image signal processing device 10 shown in FIG. 15A, the judgment unit 13 judges that the active shutter glasses 107 are not in the valid state when the communication unit 17 does not receive the predetermined signal from the active shutter glasses 107 for a predetermined period of time.

Furthermore, the judgment unit 13 can judge that the active shutter glasses 107 are not in the valid state when the communication unit 17 transmits an inquiry signal to the active shutter glasses 107, and the communication unit 17 does not receive the predetermined signal as a response to the inquiry signal.

Furthermore, the judgment unit 13 may judge whether or not the active shutter glasses 107 are in the valid state based on a condition other than the reception or non-reception of the predetermined signal from the active shutter glasses 107. Specifically, the judgment unit 13 may judge whether or not the active shutter glasses 107 are in the valid state, according to a result of analysis of captured-image data which is information from outside the image signal processing device 10, as the result of obtaining information from outside the image signal processing device 10.

FIG. 15B is a block diagram showing another example of a functional configuration of the image signal processing device 10 according to Embodiments 1 and 2.

As shown in FIG. 15B, the image signal processing device 10 includes a captured-image data obtainment unit 18, in addition to the components shown in FIG. 2 and FIG. 11.

The captured-image data obtainment 18 obtains captured-image data obtained by capturing images of a view in front of the screen on which images based on the three-dimensional image signal outputted from the output unit 12 are displayed.

The captured-image data obtainment unit 18 can be realized, for example, using the communication interface 303 of the three-dimensional image display apparatus 102 according to Embodiment 1. Furthermore, the captured-image data obtainment unit 18 can be realized, for example, using the communication interface 901 of the three-dimensional image reproduction apparatus 801 according to Embodiment 2.

Specifically, the captured-image data obtainment unit 18 obtains captured-image data obtained by, for example, having a camera set on an upper part of the display 306 (1006) of the three-dimensional image display apparatus 102 (802) capture images of the view in front of the display 306 (1006).

By analyzing the captured-image data, the judgment unit 13 judges that the active shutter glasses 107 are in the valid state when, for example, it is confirmed that the active shutter glasses 107 are being worn on a person's face.

Furthermore, by analyzing the captured-image data, the judgment unit 13 may judge whether or not the active shutter glasses 107 are in the valid state after confirming, for example, whether or not the active shutter glasses 107 are oriented to allow viewing of three-dimensional images, or whether or not the active shutter glasses 107 are performing the opening and closing operation, and so on.

It should be noted that, aside from the typical pattern matching, a method which uses image analysis to confirm whether or not parts corresponding to the lenses of the glasses are liquid crystal shutters, and so on, are available as methods for judging whether or not the glasses shown in the captured-image data are the active shutter glasses 107.

In this manner, when the judgment unit 13 judges whether or not the active shutter glasses 107 are in the valid state based on the captured-image data, the active shutter glasses 107 do not need to have the function of transmitting the predetermined signal to the device on the image displaying-side. Specifically, the judgment unit 13 can judge whether or not a conventional pair of active shutter glasses 107 is in the valid state.

It should be noted that both the above-described communication unit 17 and the captured-image data obtainment unit 18 can be called an outside-information obtainment unit, and may be provided in the image signal processing device 10 as a function included in the judgment unit 13.

Furthermore, in Embodiment 1 and Embodiment 2, the active shutter glasses 107 transmit the predetermined signal during an operational period in which the operation of alternately blocking the fields of vision of the left and right eyes of the user is performed.

Furthermore, the “operational period” is, for example, a period of time during which the power source of the active shutter glasses 107 is ON. Specifically, it is sufficient that the active shutter glasses 107 autonomously transmit the predetermined signal on a fixed time period basis, or transmits the predetermined signal as a response to an inquiry signal from the device on the image displaying-side, in the period starting from when the power switch of the active shutter glasses 107 is turned ON up to when the power switch is turned OFF.

Here, a case is assumed in which the predetermined signal is transmitted from the active shutter glasses 107 to a device on the image displaying-side, using a highly directional communication scheme such as infrared rays. In this case, even when the active shutter glasses 107 are taken off from the user, as long as the active shutter glasses 107 are facing in the direction (typically a direction squarely-facing the screen of the display device) of the device which is supposed to receive the predetermined signal, the predetermined signal from the active shutter glasses 107 can be received by the device.

Furthermore, a case is assumed in which the predetermined signal is transmitted from the active shutter glasses 107 to a device on the image displaying-side, using a non-directional communication scheme such as Bluetooth. In this case, as long as the power source of the active shutter glasses 107 is turned ON, it is possible that the predetermined signal is transmitted from the active shutter glasses 107 and received by the device even when the active shutter glasses 107 are taken off from the user and are not facing in the direction of the device which is supposed to receive the predetermined signal.

In other words, even when the active shutter glasses 107 are taken off from the user and are in a state that would normally be judged as not being in the valid state, they can also be judged as being in the valid state when some kind of condition is satisfied.

In view of this, a detection unit which detects whether or not the active shutter glasses 107 are being worn by the user may be provided to the active shutter glasses 107.

FIG. 16 is a block diagram showing another example of a functional configuration of the active shutter glasses 107 according to Embodiments 1 and 2.

The active shutter glasses 107 shown in FIG. 16 include a communication unit 41 and a detection unit 45. The communication unit 41 is realized using, for example, the communication interface 401, and is capable of receiving the predetermined signal. Furthermore, the communication unit 41 is also capable of receiving the inquiry signal transmitted from the device on the image displaying-side.

The detection unit 45 is, for example, a sensor which detects whether or not the active shutter glasses 107 in a wearing state of being worn by the user.

The detection unit 45 is realized, for example, using a contact-type sensor disposed on a part which comes into contact with the user when the active shutter glasses 107 are worn by the user.

Furthermore, the detection unit 45 may be, for example, a sensor which detects the amount of deformation or stress on the frame of the active shutter glasses 107. In this case, it is possible to judge that the active shutter glasses 107 are in the valid state when the detected value exceeds a threshold value.

The communication unit 41 transmits the predetermined signal either autonomously or as a response to an inquiry signal, when the active shutter glasses 107 are in the operational period and the detection result from the detection unit 45 indicates the wearing state.

In other words, even in the operational period, the transmission of the predetermined signal can be stopped when the active shutter glasses 107 are not in the wearing state.

Furthermore, a case is assumed in which the active shutter glasses 107 are properly worn by the user and the active shutter glasses 107 are facing in the direction of the device which is supposed to receive the predetermined signal from the active shutter glasses 107.

Even in this case, when the amount of tilt of the lateral axis of the active shutter glasses 107 with respect to the lateral axis of the three-dimensional images exceeds a predetermined range, such as when the user is lying down, it is not possible for the user to view three dimensional images clearly.

In view of this, a tilt sensor which detects the amount of tilt may be adopted as the detection unit 45.

In this case, the communication unit 41 transmits the predetermined signal, either autonomously or as a response to an inquiry signal, when the active shutter glasses 107 are in the operational period and the amount of tilt indicated in the detection result from the detection unit 45 is within the predetermined range.

In other words, even in the operational period, the transmission of the predetermined signal can be stopped when the lateral axis of the active shutter glasses 107 tilts significantly with respect to the lateral axis of the three-dimensional images.

It should be noted that when the lateral axis of the three-dimensional images is parallel with the horizontal direction, the active shutter glasses 107 stop transmitting the predetermined signal when the lateral axis of the active shutter glasses 107 tilts, for example, more than 45 degrees with respect to the horizontal direction.

Furthermore, the detection unit 45 may have both the function of detecting whether or not the active shutter glasses 107 are in the valid state described above and the function of detecting the amount of tilt of the active shutter glasses 107.

In this manner, by providing the detection unit 45 to the active shutter glasses 107, it is possible to improve the accuracy of the judgment for whether or not the active shutter glasses 107 are in the valid state, in the image signal processing device 10.

Furthermore, in Embodiments 1 and 2, the image signal processing device 10 is provided in either the three-dimensional image display apparatus (102) or the three-dimensional image reproduction apparatus (801). However, the image signal processing device 10 may be realized using both the three-dimensional image display apparatus and the three-dimensional image reproduction apparatus.

For example, in Embodiment 1, the system controller 208 of the three-dimensional image reproduction apparatus 101 may execute the process of the judgment unit 13 of judging whether or not the active shutter glasses 107 are in the active state, and the controller 302 of the three-dimensional image display apparatus 102 may execute the process of the control unit 14 of switching the output signal from the output unit 12, from the three-dimensional image signal to the two-dimensional image signal.

In addition, the image signal processing device 10 may be realized as a device that is physically independent from both the three-dimensional image display apparatus and the three-dimensional image reproduction apparatus.

For example, the image signal processing device 10 is disposed in between the three-dimensional image reproduction apparatus and the three-dimensional image display apparatus, in the image signal flow. In this case, when the active shutter glasses 107 are in the active state, the image signal processing device 10 transmits the three-dimensional image signal obtained from the three-dimensional image reproduction apparatus, as is, to the three-dimensional image display apparatus.

Furthermore, when the active shutter glasses 107 are not in the active state, the image signal processing device 10 transmits only the image signal representing the left-eye images (L1, L2, L3, . . . ) out of the three-dimensional image signal obtained from the three-dimensional image reproduction apparatus, to the three-dimensional image display apparatus, in an L1, L1, L2, L2, L3, L3 . . . , sequence. With this, it is possible to cause the three-dimensional image display apparatus to display what would appear to be two dimensional images.

Furthermore, the image signal processing device 10 may transmit the three-dimensional image signal to the three-dimensional image display apparatus and instruct the three-dimensional image display apparatus to perform control to transfer, to the display 306, only the left-eye images or only the right-eye images, by repeating each image twice.

The image signal processing device and the active shutter glasses according to the present invention have been described up to this point based on Embodiments 1 and 2 and the Supplement thereto. However, the present embodiment is not limited to the above descriptions. Various modifications to Embodiments 1 and 2 and the Supplement thereto that can be conceived by those skilled in the art, or forms configured by combining components described above without departing from the teachings of the present invention are included in the scope of the present invention.

For example, in Embodiments 1 and 2, the subject of the valid state judgment is one pair active shutter glasses 107. However, plural pairs of active shutter glasses 107 may be the subject of the judgment.

For example, when the judgment result from the judgment unit 13 indicates that at least one out of plural pairs of active shutter glasses 107 is in the valid state, the control unit 14 need not switch the output signal from the output unit 12, from the three-dimensional image signal to the two-dimensional image signal.

In other words, as long as at least one viewer is in a state which allows three-dimensional viewing, the output of the three-dimensional image signal may be continued regardless of whether or not other viewers are capable of three-dimensional viewing.

Furthermore, in the case were all the viewers are required to view three-dimensional images, the control unit 14 may switch the output signal from the output unit 12, from the three-dimensional image signal to the two-dimensional image signal, when any one of the plural pairs of active shutter glasses 107 ceases to be in the valid state.

Furthermore, the control unit 14 may switch the output signal from the output unit 12, from the three-dimensional image signal to the two-dimensional image signal, when, out of the plural pairs of active shutter glasses 107, the pairs of active shutter glasses 107 that are not in the valid state reach a majority.

### INDUSTRIAL APPLICABILITY

The present invention can be applied as an image signal processing device in a three-dimensional image display apparatus which displays three-dimensional images, and in a three-dimensional image reproduction apparatus which generates a three-dimensional image signal by decoding a three-dimensional image stream. In particular, the present invention can be applied as (i) an image signal processing device used in an apparatus that alternately outputs left image signals and right image signals which compose three-dimensional images, and allows the images represented by the right and left signals to be viewed alternately in a left and right eye using a pair of active shutter glasses, and as (ii) such active shutter glasses.

What is claimed is:

1. An image signal processing device comprising:
an image signal obtainment unit configured to obtain a three-dimensional image signal for allowing three-dimensional viewing of images using a pair of active shutter glasses;
an output unit configured to output the three-dimensional image signal;
a judgment unit configured to judge whether or not the pair of active shutter glasses is in a valid state which allows three-dimensional viewing using the pair of active shutter glasses, based on a result of obtaining information from outside said image signal processing device; and
a control unit configured to switch, by controlling said output unit, an output signal from said output unit, from the three-dimensional image signal to a two-dimensional image signal associated with the three-dimensional image signal, when a result of the judgment by said judgment unit indicates that the pair of active shutter glasses is not in the valid state.

2. The image signal processing device according to claim 1, further comprising
a communication unit configured to receive a predetermined signal from the pair of active shutter glasses, the predetermined signal being the information from outside said image signal processing device,
wherein said judgment unit is configured to judge that the pair of active shutter glasses is not in the valid state when said communication unit does not receive the predetermined signal from the pair of active shutter glasses.

3. The image signal processing device according to claim 2,
wherein said judgment unit is configured to judge that the pair of active shutter glasses is not in the valid state when said communication unit does not receive the predetermined signal for a predetermined period of time.

4. The image signal processing device according to claim 2,
wherein said communication unit is configured to transmit an inquiry signal to the pair of active shutter glasses, and
said judgment unit is configured to judge that the pair of active shutter glasses is not in the valid state when said communication unit does not receive the predetermined signal as a response to the inquiry signal.

5. The image signal processing device according to claim 1, further comprising
a captured-image data obtainment unit configured to obtain captured-image data which is the information from outside said image signal processing device, obtained by capturing an image of a view in front of a screen on which images based on the three-dimensional image signal outputted from said output unit are displayed,
wherein said judgment unit is configured to judge whether or not the pair of active shutter glasses is in the valid state, according to a result of an analysis of the captured-image data.

6. The image signal processing device according to claim 1,
wherein, when the result of the judgment indicates that the pair of active shutter glasses is not in the valid state, said control unit is configured to switch, by controlling said output unit, the output signal from said output unit, from the three-dimensional image signal to an image signal which is the two-dimensional image signal and is for displaying information indicating an occurrence of a state caused by the pair of active shutter glasses not being in the valid state.

7. A pair of active shutter glasses which performs an operation of alternately blocking a field of vision of a left eye and a field of vision of a right eye of a user in synchronization with switching between each of left-eye images and right-eye images which are displayed alternately, said pair of active shutter glasses comprising
a communication unit configured to transmit, during an operational period, a predetermined signal which can be received by a device on a displaying-side of the left-eye images and the right-eye images, the operational period being a period of time during which said pair of active shutter glasses performs the operation.

8. The pair of active shutter glasses according to claim 7,
wherein, when it is the operational period and an inquiry signal is received from the device on the displaying-side, said communication unit is configured to transmit the predetermined signal as a response to the inquiry signal.

9. The pair of active shutter glasses according to claim 7, further comprising
a detection unit configured to detect whether or not said pair of active shutter glasses is in a wearing state which is a state of being worn by the user,
wherein said communication unit is configured to transmit the predetermined signal when it is the operational period and a result of the detection by said detection unit indicates the wearing state.

10. The pair of active shutter glasses according to claim 7, further comprising
a detection unit configured to detect an amount of tilt of a lateral axis of said pair of active shutter glasses with respect to a lateral axis of three-dimensional images based on the left-eye images and the right-eye images,
wherein said communication unit is configured to transmit the predetermined signal when it is the operational period and a result of the detection by said detection unit indicates that the amount of tilt is within a predetermined range.

11. An image signal processing method executed by an image signal processing device, said method comprising:
obtaining a three-dimensional image signal for allowing three-dimensional viewing of images using a pair of active shutter glasses;
outputting the three-dimensional image signal;
judging whether or not the pair of active shutter glasses is in a valid state which allows three-dimensional viewing using the pair of active shutter glasses, based on a result of obtaining information from outside the image signal processing device; and
switching an output signal outputted in said outputting, from the three-dimensional image signal to a two-dimensional image signal associated with the three-dimensional image signal, when a result of the judgment in said judging indicates that the pair of active shutter glasses is not in the valid state.

12. A program recorded on a non-statutory computer-readable recording medium, for controlling operations of an image signal processing device, said program causing a computer to execute:
obtaining a three-dimensional image signal for allowing three-dimensional viewing of images using a pair of active shutter glasses;
outputting the three-dimensional image signal;
judging whether or not the pair of active shutter glasses is in a valid state which allows three-dimensional viewing using the pair of active shutter glasses, based on a result of obtaining information from outside the image signal processing device; and
switching an output signal outputted in said outputting, from the three-dimensional image signal to a two-dimensional image signal associated with the three-dimensional image signal, when a result of the judgment in said judging indicates that the pair of active shutter glasses is not in the valid state.
